(19) United States
(12) Patent Application Publication
(10) Pub. No.: US 2026/0177804 A1
(43) Pub. Date: Jun. 25, 2026

(54) SIGHT AND PATTERN STRUCTURE THEREOF

(71) Applicant: Asia Optical Co., Inc., Taichung (TW)

(72) Inventor: Ken Chiakan Chang, Taichung (TW)

(21) Appl. No.: 19/422,692

(22) Filed: Dec. 17, 2025

(30) Foreign Application Priority Data
Dec. 23, 2024 (TW) 113150197

(51) Int. Cl. G02B 23/04

(52) U.S. Cl. CPC G02B 23/04

(57) ABSTRACT

A pattern structure and a sight utilizing the pattern structure are provided. The pattern structure includes a first pattern and a second pattern. The first pattern is corresponded to a first geometric shape and has a first color. The second pattern is corresponded to a second geometric shape. The inner edge of the second pattern is placed corresponding to the outer edge of the first pattern. The outer edge of the first pattern and the inner edge of the second pattern have a first characteristic interval therebetween that is uniform. The second pattern includes a first end, a second end disposed opposite to the first end, and an inner edge connecting the first end and the second end. The first end and the second end have a second characteristic interval therebetween.

### BACKGROUND OF THE INVENTION

### FIELD OF THE INVENTION

The invention relates to a technical field of a sight, and more particularly to a pattern structure, and a sight and a range finding device provided with the pattern structure.

### DESCRIPTION OF THE RELATED ART

A sniper rifle is generally equipped with a sight. A shooter can operates the sight to precisely match the shooter's visual trajectory and the bullet trajectory of the sniper rifle in an optical way, so that the bullet can hit the target at long ranges.

An existing sight uses light emitting diodes (LEDs) to generate the reticle. The shooter can aim at a target with the reticle for shooting. However, the reticle of a sight generally has a predetermined graphic pattern and a predetermined color. For example, the reticle of a red dot sight is a red dot. Different products of sights have different kinds of reticles. Therefore, the shooter needs to change the sight if he/she wants to change the reticle. There is another kind of sight, wherein the reticle has two different graphic patterns which can be selected to be shown. However, the two different graphic patterns are shown by using different light emitting diodes which are placed at different locations. Therefore, the shown graphic patterns cannot be overlapped.

Different reticles are used in different aiming modes. In some cases, the shooter needs to switch between different reticles for operation in different aiming modes. With existing sight products, when a shooter switches between reticles with different graphic patterns, he or she must either replace a different sight or aim at the target with different positions of the same sight.

### BRIEF SUMMARY OF THE INVENTION

The invention provides a pattern structure and a sight utilizing the pattern structure to address the problem that a shooter may miss the target because of the requirement of switching between different patterns in different aiming modes.

The pattern structure in accordance with an exemplary embodiment of the invention includes a first pattern and a second pattern. The first pattern is formed by arrangement of at least one first light source unit and corresponded to a first geometric shape. The second pattern is formed by arrangement of at least one second light source unit and corresponded to a second geometric shape. The first pattern includes a first color and an outer edge. The second pattern includes a first end, a second end disposed opposite to the first end, and an inner edge connecting the first end and the second end. The inner edge of the second pattern is placed corresponding to the outer edge of the first pattern. The outer edge of the first pattern and the inner edge of the second pattern have a first characteristic interval therebetween. The first end and the second end have a second characteristic interval therebetween. Both the first characteristic interval and the second characteristic interval are outside the first pattern and the second pattern. Both the first characteristic interval and the second characteristic interval are outside the first light source unit and the second light source unit. The first light source unit and the second light source unit individually includes a first electrode layer, a first reflector layer, an active layer, a second reflector layer, a light-emitting side, and a second electrode layer arranged in order. The pattern structure satisfies a first group of conditions or a second group of conditions. The first group of conditions includes L2/L1≧3 or L1≦19.95µm, where L1 is the first characteristic interval and L2 is the second characteristic interval. The second group of conditions includes L1≦19.95µm, L2≦19.95µm, or 0.95≦L2/L1≦1.05, where L1 is the first characteristic interval and L2 is the second characteristic interval.

In another exemplary embodiment, the first light source unit and the second light source are resonant cavity light emitting diodes.

In yet another exemplary embodiment, the pattern structure is configured to operate in a first aiming mode or in a second aiming mode. The first pattern is illuminated in the first aiming mode. Both the first pattern and the second pattern are illuminated in the second aiming mode. A prime geometric shape is a set. Both the first geometric shape and the second geometric shape are subsets of the prime geometric shape, or alternatively, the first geometric shape is a part of the prime geometric shape and the second geometric shape is also a part of the prime geometric shape.

In another exemplary embodiment, when the first group of conditions is satisfied, the pattern structure is configured as follows:

the prime geometric shape is a triangle with a first dimension;

the first geometric shape is a third circle with a fourth diameter;

a third geometric shape is a fourth circle with a third diameter;

centers of the third circle and the fourth circle are placed at a vertex of the triangle;

a prime geometric shape is a set;

the second geometric shape is a difference set of the prime geometric shape and the third geometric shape;

the first geometric shape is a subset of the third geometric shape.

In yet another exemplary embodiment, the second pattern further includes a second color. The first color of the first pattern and the second color of the second pattern are identical or different. The first characteristic interval between the outer edge of the first pattern and the inner edge of the second pattern is uniform.

In another exemplary embodiment, when the second group of conditions is satisfied, the pattern structure is configured as follows:

a prime geometric shape is a set;

both the first geometric shape and the second geometric shape are subsets of the prime geometric shape, or alternatively, the first geometric shape is a part of the prime geometric shape and the second geometric shape is also a part of the prime geometric shape.

In another exemplary embodiment, when the second group of conditions is satisfied, the pattern structure satisfies one or any combination of the following conditions 2.85≦d3/d2≦3.5; 1.9≦d6/d2≦2.1; 8.55≦A2/A1≦12; 1.98≦A1/A3≦6; 2.85≦A3/A2≦4.6; 18.05µm≦L1≦19.95µm, and 18.05µm≦L2≦19.95µm, where d2 is the second diameter, d3 is the third diameter, d6 is the sixth diameter, A1 is the area of first pattern, A2 is the area of second pattern, A3 is the area of the first characteristic interval, L1 is the first characteristic interval and L2 is the second characteristic interval.

The invention also provides a sight. In an embodiment, the sight includes an objective lens unit and the above-mentioned pattern structure. The objective lens unit includes an object side surface and an image side surface. The object side surface and the image side surface define a first optical axis. The first light source unit and the second light source unit are placed at a side of the image side surface. The first light source unit and the second light source unit are configured to generate light beams, and the light beams are reflected by the objective lens unit and propagate along the first optical axis to be viewed.

In another exemplary embodiment, the sight includes an eyepiece lens unit, a relay lens unit, an objective lens unit and the above-mentioned pattern structure. The relay lens unit includes a second image plane and defines a second optical axis. The objective lens unit includes a first image plane. the objective lens unit and the eyepiece lens unit are configured to form a first optical axis. The relay lens unit is disposed between the objective lens unit and the eyepiece lens unit. The second optical axis is movable and adjustable to be parallel to the first optical axis. The first light source unit and the second light source unit are placed on the first image plane, or the first light source unit and the second light source unit are placed on the second image plane. The first light source unit and the second light source unit are configured to generate light beams, and the light beams propagate along the first optical axis and toward the eyepiece lens unit such that the pattern structure can be viewed through the eyepiece lens unit.

The invention also provides a range-finding device which includes an eyepiece lens unit, an objective lens unit wherein the objective lens unit and the eyepiece lens unit are configured to form a first optical axis, a light emitting unit which is configured to generate an emitting light beam and configured to form a second optical axis, wherein the emitting light beam is reflected by a target object to form a receiving light beam, and the first optical axis and the second optical axis are in parallel or coincide, a calculating unit, a light receiving unit configured for receiving the receiving light beam, for the calculating unit to generate a distance data, a relay lens unit, and the above-mentioned pattern structure. The first light source unit and the second light source unit are disposed on the first optical axis, or alternatively, the first light source unit and the second light source unit are disposed apart from the first optical axis. When the first light source unit and the second light source unit are disposed on the first optical axis, the first light source unit and the second light source unit generate light beams, and the light beams propagate along the first optical axis and toward the eyepiece lens unit such that the pattern structure can be viewed through the eyepiece lens unit. When the first light source unit and the second light source unit are disposed apart from the first optical axis, the first light source unit and the second light source unit generate light beams and the light beams pass through the relay lens, coincide with the first optical axis, and advance such that the pattern structure can be viewed through the eyepiece lens unit.

In another embodiment, the pattern structure includes a first pattern and a second pattern. The first pattern is formed by arrangement of at least one first light source unit and corresponded to a first geometric shape. The second pattern is formed by arrangement of at least one second light source unit and corresponded to a second geometric shape. The first pattern includes a first color and an outer edge. The second pattern includes a first end, a second end disposed opposite to the first end, and an inner edge connecting the first end and the second end. The inner edge of the second pattern is placed corresponding to the outer edge of the first pattern. The outer edge of the first pattern and the inner edge of the second pattern have a first characteristic interval therebetween that is uniform. The first end and the second end have a second characteristic interval therebetween. A prime geometric shape is a set. Both the first geometric shape and the second geometric shape are subsets of the prime geometric shape, or alternatively, the first geometric shape is a part of the prime geometric shape and the second geometric shape is also a part of the prime geometric shape. The first light source unit and the second light source unit individually includes a first electrode layer, a first reflector layer, an active layer, a second reflector layer, a light-emitting side, and a second electrode layer arranged in order. The prime geometric shape is a first circle with a first diameter. The first geometric shape is a second circle with a second diameter. The second geometric shape is an annular sector with a third diameter. The inner edge of the second pattern defines a sixth diameter. The first diameter is greater than the second diameter and is equal to the third diameter. The sixth diameter is greater than the second diameter and is less than the first diameter. Centers of the first circle, the second circle and the annular sector coincide. The first characteristic interval and the second characteristic interval are equal, or the first characteristic interval and the second characteristic interval are not equal. The first geometric shape and the second geometric shape satisfy one or any combination of the following conditions: 2.85≦d3/d2≦3.5; 1.9≦d6/d2≦2.1; 8.55≦A2/A1≦12; 1.98≦A1/A3≦6; 2.85≦A3/A2≦4.6; 18.05µm≦L1≦19.95µm; 18.05µm≦L2≦19.95µm, where d2 is the second diameter, d3 is the third diameter, d6 is the sixth diameter, A1 is the area of first pattern, A2 is the area of second pattern, A3 is the area of the first characteristic interval, L1 is the first characteristic interval and L2 is the second characteristic interval.

In yet another exemplary embodiment, the first light source unit and the second light source are resonant cavity light emitting diodes.

In another exemplary embodiment, the pattern structure is configured to operate in a first aiming mode or in a second aiming mode. The first pattern is illuminated in the first aiming mode. Both the first pattern and the second pattern are illuminated in the second aiming mode.

In yet another exemplary embodiment, the second pattern further includes a second color. The first color of the first pattern and the second color of the second pattern are identical or different. The first characteristic interval between the outer edge of the first pattern and the inner edge of the second pattern is uniform.

In another exemplary embodiment, both the first characteristic interval and the second characteristic interval are outside the first pattern and the second pattern. Both the first characteristic interval and the second characteristic interval are outside the first light source unit and the second light source unit.

The invention also provides a range-finding device which includes an eyepiece lens unit, an objective lens unit wherein the objective lens unit and the eyepiece lens unit are configured to form a first optical axis, a light emitting unit which is configured to generate an emitting light beam and configured to form a second optical axis, wherein the emitting light beam is reflected by a target object to form a receiving light beam, and the first optical axis and the second optical axis are in parallel or coincide, a calculating unit, a light receiving unit configured for receiving the receiving light beam, for the calculating unit to generate a distance data, a relay lens unit; and the above-mentioned pattern structure. The first light source unit and the second light source unit are disposed on the first optical axis, or alternatively, the first light source unit and the second light source unit are disposed apart from the first optical axis. When the first light source unit and the second light source unit are disposed on the first optical axis, the first light source unit and the second light source unit generate light beams, and the light beams propagate along the first optical axis and toward the eyepiece lens unit such that the pattern structure can be viewed through the eyepiece lens unit. When the first light source unit and the second light source unit are disposed apart from the first optical axis, the first light source unit and the second light source unit generate light beams and the light beams pass through the relay lens, coincide with the first optical axis, and advance such that the pattern structure can be viewed through the eyepiece lens unit.

The invention also provides a sight which includes an objective lens unit and the above-mentioned pattern structure. The objective lens unit includes an object side surface and an image side surface. The object side surface and the image side surface define a first optical axis. The first light source unit and the second light source unit are placed at a side of the image side surface. The first light source unit and the second light source unit are configured to generate light beams, and the light beams are reflected by the objective lens unit and propagate along the first optical axis to be viewed.

The invention also provides a sight which includes an eyepiece lens unit, a relay lens unit, an objective lens unit and the above-mentioned pattern structure. The relay lens unit includes a second image plane and defining a second optical axis. The objective lens unit includes a first image plane. The objective lens unit and the eyepiece lens unit are configured to form a first optical axis. The relay lens unit is disposed between the objective lens unit and the eyepiece lens unit. The second optical axis is movable and adjustable to be parallel to the first optical axis. The first light source unit and the second light source unit are placed on the first image plane, or the first light source unit and the second light source unit are placed on the second image plane. The first light source unit and the second light source unit are configured to generate light beams, and the light beams propagate along the first optical axis and toward the eyepiece lens unit such that the pattern structure can be viewed through the eyepiece lens unit.

The invention also provides a telescope which includes an eyepiece lens unit, a magnifying unit, an objective lens unit and the above-mentioned pattern structure. The magnifying unit includes a second image plane and defining a second optical axis. The objective lens unit includes a first image plane. The objective lens unit and the eyepiece lens unit are configured to form a first optical axis. The magnifying unit is disposed between the objective lens unit and the eyepiece lens unit. The second optical axis is movable and adjustable to be parallel to the first optical axis. The first light source unit and the second light source unit are placed on the first image plane, or the first light source unit and the second light source unit are placed on the second image plane. The first light source unit and the second light source unit are configured to generate light beams, and the light beams propagate along the first optical axis and toward the eyepiece lens unit such that the pattern structure can be viewed through the eyepiece lens unit.

The sight of the invention is provided with a pattern structure in which a first pattern and a second pattern are disposed in the same zone. The first pattern is corresponded to a first geometric shape. The second pattern is corresponded to a second geometric shape. The first geometric shape and the second geometric shape are derived from a prime geometric shape. By such arrangement, no matter what aiming pattern (the first pattern, the second pattern, or both) is illuminated, all the aiming patterns can be shown in the same zone. The shooter or the user of a rangefinder can quickly switch between the two aiming modes and can quickly track or hit the target.

### BRIEF DESCRIPTION OF THE DRAWINGS

FIG. 1 is a schematic view of a pattern structure in accordance with a first embodiment of the invention, showing how a first geometric shape of a first pattern and a second geometric shape of a second pattern are formed or derived from a prime geometric shape.

FIG. 2 is a schematic view of the pattern structure of FIG. 1 showing different aiming modes wherein the first pattern or the second pattern is illuminated.

FIG. 3 is a schematic view of a pattern structure in accordance with a second embodiment of the invention, showing how a first geometric shape of a first pattern and a second geometric shape of a second pattern are formed or derived from a prime geometric shape.

FIG. 4 is a schematic view of the pattern structure of FIG. 3 showing different aiming modes wherein only the first pattern is illuminated, or both the first pattern and the second pattern are illuminated.

FIG. 5 is a schematic view of sights in accordance with the embodiments of the invention.

FIG. 6 is a schematic view of a range-finding device in accordance with the embodiments of the invention.

### DETAILED DESCRIPTION OF THE INVENTION

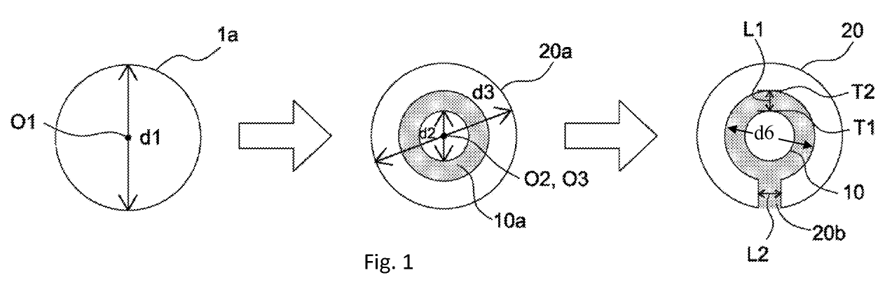

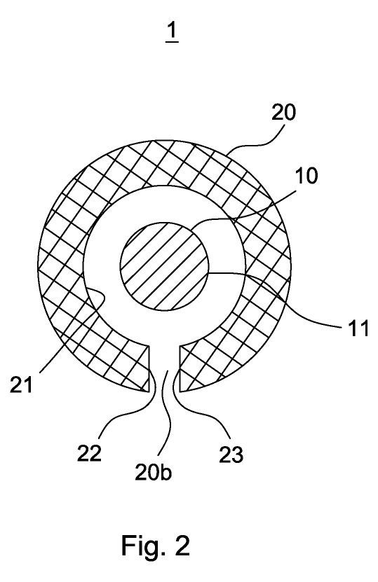

Referring to FIGS. 1 and 2, a pattern structure 1 in accordance with a first embodiment of the invention includes a first pattern 10 and a second pattern 20. The first pattern 10 is corresponded to a first geometric shape 10a and has a first color. The second pattern 20 is corresponded to a second geometric shape 20a and has a second color. The first geometric shape 10a and the second geometric shape 20a are part of or derived from a prime geometric shape 1a.

One or more first light source units are arranged to form the first pattern 10, while one or more second light source units are arranged to form the second pattern 20. The first light source unit(s) and the second light source unit(s) are, for example, resonant cavity light emitting diodes (RCLED). Therefore, the first light source unit(s) and the second light source unit(s) individually include an active layer, a first distributed Bragg reflector (DBR) layer, a second distributed Bragg reflector layer, a substrate layer, a first electrode layer, and a second electrode layer. The first distributed Bragg reflector layer and the second distributed Bragg reflector layer are placed on opposite sides of the active layer. The substrate layer is placed next to the first distributed Bragg reflector layer. The first electrode layer is placed next to the substrate layer. The second electrode layer is placed next to the second distributed Bragg reflector layer. The first distributed Bragg reflector layer includes an N-type semiconductor layer. The second distributed Bragg reflector layer includes a P-type semiconductor layer. The first distributed Bragg reflector layer and the second distributed Bragg reflector layer are disposed opposite to each other to form a resonant cavity therebetween (especially Fabry-Perot Cavity). The active layer is placed in the resonant cavity and is in the form of a quantum well. The distance between the Bragg reflector surface and a light-emitting side of the light source unit is smaller than the distance between the first Bragg reflector surface and a light-emitting side of the light source unit. The first electrode layer and the second electrode layer are configured to drive the N-type semiconductor layer and the P-type semiconductor layer respectively, so that the electrons of the N-type semiconductor layer and the holes of the P-type semiconductor layer can combine in the active layer to emit light (spontaneous emission). The light emitted by the active layer is reflected back and forth in the resonant cavity between the first distributed Bragg reflector layer and the second distributed Bragg reflector layer, and a resonance phenomenon or standing wave is formed in the resonant cavity.

As shown in FIG. 1, in the first embodiment, the prime geometric shape 1a is a first circle with a first diameter d1. The first geometric shape 10a is a second circle with a second diameter d2. The second geometric shape 20a is an annulus and has a third diameter d3. Therefore, the first geometric shape 10a and the second geometric shape are part of the prime geometric shape.

If the prime geometric shape 1a is a set, then the first geometric shape 10a and the second geometric shape 20a are both subsets of the prime geometric shape 1a, and the subset defined by the first geometric shape 10a and the subset defined by the second geometric shape 20a have no intersection. In another embodiment, the subset defined by the first geometric shape 10a and the subset defined by the second geometric shape 20a may have intersection. For example, the first geometric shape is a circle, the second geometric shape is crosshairs, and the center of the circle and the center of the crosshairs coincide. By such arrangement, the first pattern 10 and the second pattern 20 can be provided in the same zone.

In the first embodiment, the center O1 of the first circle, the center O2 of the second circle, and the center O3 of the annulus coincide (to take up the same place). The inner edge of the second pattern defines a sixth diameter d6. The first diameter d1 is equal to the third diameter d3, and the third diameter d3 is greater than the second diameter d2. The sixth diameter d6 is greater than the second diameter d2, and less than the first diameter d1. The first geometric shape 10a is therefore surrounded by the second geometric shape 20a, namely the first pattern 10 is surrounded by the second pattern 20. In the first embodiment, the first diameter d1 and the third diameter d3 are 6MOA (Minute of Arc), the second diameter d2 is 2MOA, the sixth diameter d6 is about 4MOA, and the ratio of the third diameter d3 to the second diameter d2 is 3 (d3/d2=3). However, the invention is not limited thereto. The maximal value of the ratio is 10 (MAX(d3/d2)=3.5). In the first embodiment, the ratio of the third diameter d3 to the second diameter d2 is ranged from 2.85 to 3.5 (2.85≦d3/d2≦3.5). The ratio of the sixth diameter d6 to the second diameter d2 is 2 (d6/d2=2). However, the invention is not limited thereto. In some other embodiments, the ratio of the sixth diameter d6 to the second diameter d2 may be ranged from 1.9 to 2.1 (1.9≦d6/d2≦2.1). Further, the ratio of the area of the second pattern to the area of the first pattern 10 is 9:1. Similarly, the invention is not limited thereto. The maximal value of the ratio is 100:1. In the first embodiment, the ratio of the area A2 of the second pattern 20 to the area A1 of the first pattern 10 is ranged from 8.55 to 12 (8.55≦A2/A1≦12). In the first embodiment, the ratio of an area of the first pattern 10 to an area A3 of a first characteristic interval is 1.98 wherein the area A3 is obtained from subtracting the area A2 of the second pattern 20 from an area having the sixth diameter (The area A3 is the grayed area in FIG. 1). The ratio of the area A1 of the first pattern 10 to the area A3 of the first characteristic interval is ranged from 1.98 to 6 (1.98≦A1/A3≦6). In the first embodiment, the ratio of the area A3 of the first characteristic interval to the area of the second pattern 20 is 2.85. However, the invention is not limited thereto. In the invention, the ratio of the area A3 of first characteristic interval to the area A2 of the second pattern 20 is ranged from 2.85 to 4.6 (2.85≦A3/A2≦4.6).

There is a first characteristic interval L1 between the outer edge 11 of the first pattern 10 and the inner edge 21 of the second pattern 20. The first characteristic interval L1 refers to the vertical distance between the tangent line T2 of the inner edge 21 of the second pattern 20 and the tangent line T1 of the outer edge 11 of the first pattern 10, or the distance between the outer periphery of the first pattern (or the second circle) 10 and the inner periphery of the second pattern (or the annulus) 20. In the first embodiment, the first characteristic interval L1 is 19μm (micro meter). In the invention, the first characteristic interval is ranged from 18.05μm to 19.95μm (18.05μm≦L1≦19.95μm). Due to the divergence angles of the light beams that are emitted by the first and second light source units, the first pattern 10 and the second pattern 20 having the first characteristic interval L1 therebetween are not separated in vision, but appear to form a prime geometric shape 1a.

The outer edge 11 of the first pattern 10 and the inner edge 21 of the second pattern 20 have similar contours (circular or arc-shaped). Further, the first characteristic interval L1 between the outer edge 11 of the first pattern 10 and the inner edge 21 of the second pattern 20 is uniform. That is, the outer periphery of the first pattern (or the second circle) 10 and the inner periphery of the second pattern (or the annulus) 20 are equally spaced.

In the first embodiment, the second pattern 20 has a first end 22 and a second end 23 at a position of 270 degrees. The first end 22 and the second end 23 are disposed opposite to each other and are spaced apart by a distance. Therefore, the second pattern 20 has a gap 20b formed between the first end 22 and the second end 23. The width of the gap 20b is a second characteristic interval L2. In the first embodiment, the second characteristic interval L2 is 19μm. However, the invention is not limited thereto. In the invention, the second characteristic interval is ranged from 18.05μm to 19.95μm (18.05μm≦L2≦19.95μm).

In the first embodiment, both the first characteristic interval L1 and the second characteristic interval L2 are outside the first pattern 10 and the second pattern 20. Further, both the first characteristic interval L1 and the second characteristic interval L2 are disposed outside the first light source unit(s) and the second light source unit(s). As described above, the first characteristic interval L1 is ranged from 18.05μm to 19.95μm (18.05μm≦L1≦19.95μm) and the second characteristic interval L2 is ranged from 18.05μm to 19.95μm (18.05μm≦L2≦19.95μm). In a preferred embodiment, the first characteristic interval L1 is substantially same as the second characteristic interval L2, namely 0.95≦L2/L1≦1.05. Under such a circumstance, the first pattern 10 and the second pattern 20 are not separated in vision but appear to form a prime geometric shape 1a, when both the first pattern and the second pattern are illuminated.

Referring to FIG. 2, the pattern structure 1 of the first embodiment has a first aiming mode and a second aiming mode. In the first aiming mode, the first pattern 10 is illuminated. In the second aiming mode, the second pattern 20 is illuminated. Further, the first pattern 10 in the first aiming mode has a first color, and the second pattern 20 in the second aiming mode has a second color. In the first embodiment, the first color is red and the second color is green. The user is able to switch the operation between the first aiming mode and the second aiming mode.

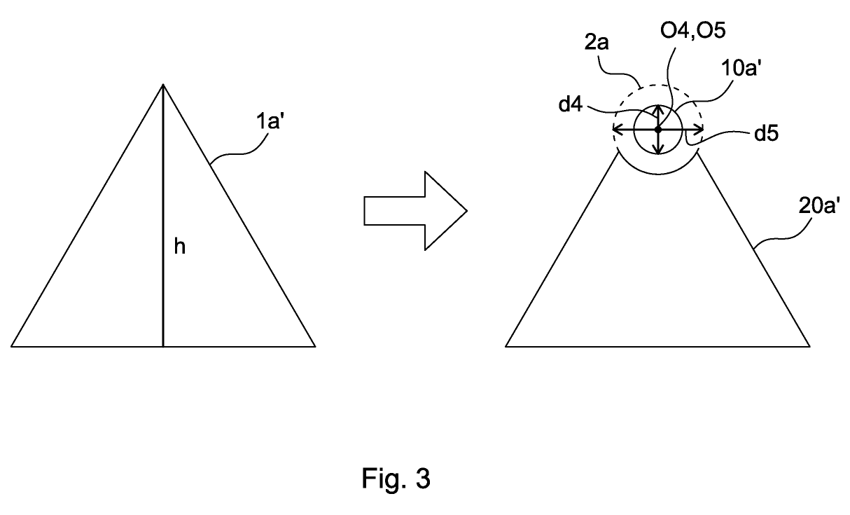

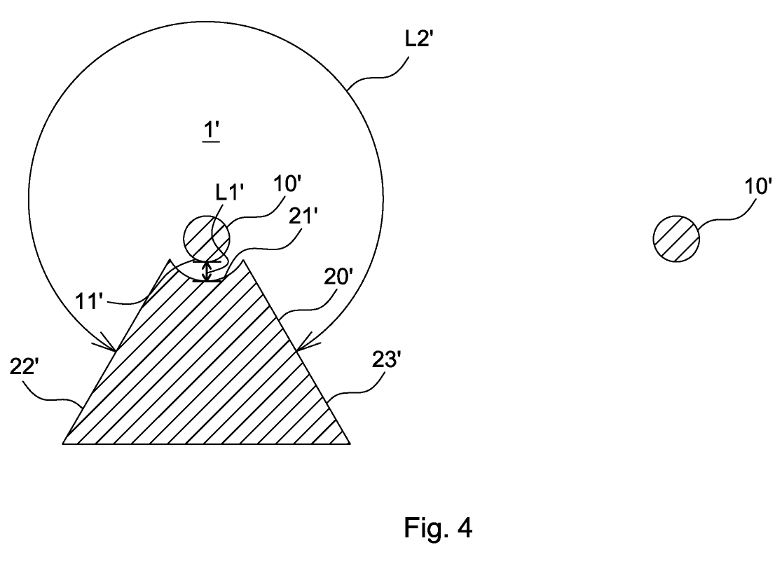

Referring to FIGS. 3 and 4, a pattern structure 1’ in accordance with a second embodiment of the invention includes a first pattern 10’ and a second pattern 20’. The first pattern 10’ is corresponded to a first geometric shape 10a’ and has a first color. The second pattern 20’ is corresponded to a second geometric shape 20a’ and has a second color. The first geometric shape 10a’ and the second geometric shape 20a’ are part of or derived from a prime geometric shape 1a’.

As shown in FIG. 3, in the second embodiment, the prime geometric shape 1a’ is a triangle with a first dimension h. Specifically, the prime geometric shape 1a’ is an isosceles triangle. The first geometric shape 10a’ is a third circle having a fourth diameter d4. The second geometric shape 20a’ is a triangle having its top replaced with an arc. The arc is a part of a fourth circle (shown with a dash line in FIG. 3) which has a fifth diameter d5. The center O4 of the third circle and the center O5 of the fourth circle coincide. It is therefore understood that both the first geometric shape 10a’ and the second geometric shape 20a’ are part of the prime geometric shape 1a’.

If the prime geometric shape 1a’ is a set, then the first geometric shape 10a’ is a subset of a third geometric shape (the fourth circle) 2a, and the second geometric shape 20a' is a difference set of the prime geometric shape 1a' and the third geometric shape (the fourth circle) 2a, namely the elements in the difference set belong to the prime geometric shape 1a’ but not to the third geometric shape 2a. The set defined by the first geometric shape 10a’ and the set defined by the second geometric shape 20a’ have no intersection, and the first geometric shape 10a’ is placed in the prime geometric shape 1a’. In another embodiment, the set defined by the first geometric shape and the set defined by the second geometric shape may have intersection. For example, the first geometric shape is an annulus connected to the second geometric shape. By such arrangement, the first pattern 10’ and the second pattern 20’ are provided in the same zone.

In the second embodiment, the first dimension h is 10MOA, the fourth diameter d4 is 2MOA, and the fifth diameter d5 is 4MOA. There is a first characteristic interval L1’ between the outer edge 11’ of the first pattern (the third circle) 10’ and the inner edge 21’ of the second pattern 20’. The first characteristic interval L1’ refers to the distance between the outer periphery of the first pattern (the third circle) 10’ and the arc-shaped top edge of the second pattern 20’. In the second embodiment, the first characteristic interval L1’ is 19μm. In the invention, the first characteristic interval is ranged from 18.05μm to 19.95μm (18.05μm≦L1≦19.95μm). The outer edge 11’ of the first pattern (the third circle) 10’ and the inner edge 21’ of the second pattern 20 have similar contours (arc-shaped). Further, the first characteristic interval L1’ between the outer edge 11’ of the first pattern (the third circle) 10’ and the inner edge 21’ of the second pattern 20’ is uniform. Due to the divergence angles of the light beams that are emitted by the first and second light source units, the first pattern 10’ and the second pattern 20’ having the first characteristic interval L1’ therebetween are not separated in vision, but appear to form a prime geometric shape 1a’.

The second pattern 20’ has a first end 22’ and a second end 23’ which are two sides (the legs) of an isosceles triangle. There is a second characteristic interval L2’ between the first end 22’ and the second end 23’. The first characteristic interval L1’ and the second characteristic interval L2’ are not equal. In a preferred embodiment, the first characteristic interval L1’ is ranged from 18.05μm to 19.95μm (18.05μm≦L1’≦19.95μm), and the ratio of the second characteristic interval L2’ to the first characteristic interval L1’ is at least 3 (L2’/L1’≧3).

In the second embodiment, both the first characteristic interval L1’ and the second characteristic interval L2’ are outside the first pattern 10’ and the second pattern 20’. Further, both the first characteristic interval L1’ and the second characteristic interval L2’ are disposed outside the first light source units and the second light source units.

Referring to FIG. 4, the pattern structure 1’ of the second embodiment has a first aiming mode and a third aiming mode. In the first aiming mode, the first pattern 10’ is illuminated. In the third aiming mode, both the first pattern 10’ and the second pattern 20’ are illuminated. Further, the first pattern 10’ in the first aiming mode has a first color. The first pattern 10’ and the second pattern 20’ in the third aiming mode have a second color. In the second embodiment, the first color is red and the second color is also red. The user is able to switch the operation between the first aiming mode and the third aiming mode.

The sight of the invention is provided with a pattern structure in which a first pattern and a second pattern are disposed in the same zone. The first pattern is corresponded to a first geometric shape. The second pattern is corresponded to a second geometric shape. The first geometric shape and the second geometric shape are part of or derived from a prime geometric shape. By such arrangement, different aiming patterns can be shown in the same zone when the first pattern and/or the second pattern are illuminated. The shooter or the user of a rangefinder can quickly switch between the two aiming modes and can quickly track or hit the target.

In the invention, the first characteristic interval is less than or equal to 19.95μm, and the second characteristic interval is also less than or equal to 19.95μm. It will fail to completely present the patterns if the characteristic intervals are too large. The invention is able to avoid this problem by setting the upper limit (19.95μm) of the first and second characteristic intervals. Further, in the invention, the first characteristic interval is greater than or equal to 18.05μm, and the second characteristic interval is also greater than or equal to 18.05μm. It may completely present the patterns if the characteristic intervals are too small. However, the light source area will be too large (the diameter of the area will also be large), the cost will increase, and the patterns will be overlapped that causes poor visual perception. The invention is able to avoid this problem by setting the lower limit (18.05μm) of the first and second characteristic intervals.

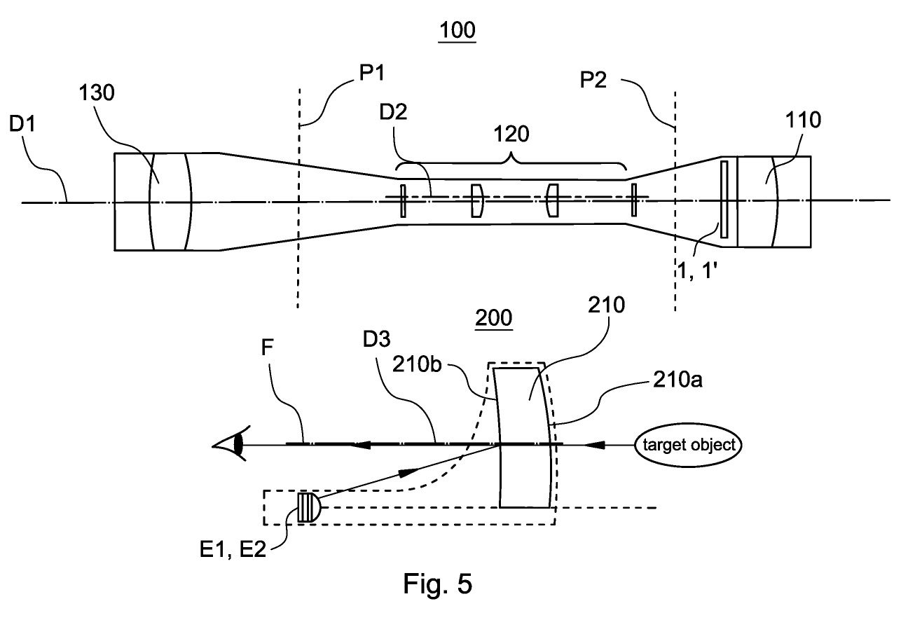

The sight of the invention may be a telescopic sight 100 as shown in the upper part of FIG. 5, or a red dot sight 200 as shown in the lower part of FIG. 5, either of which can be provided with the pattern structure described above. In the telescopic sight 100, an eyepiece lens unit 110, a relay lens unit 120 and an objective lens unit 130 are included. The relay lens unit 120 is disposed between the eyepiece lens unit 110 and the objective lens unit 130. The eyepiece lens unit 110 and the objective lens unit 130 define a first optical axis D1. The objective lens unit 130 has a first image plane P1 which is in the focal length position of the entire objective lens unit 130. The relay lens unit 120 has a second optical axis D2 and a second image plane P2. The second image plane P2 is in the focal length position of the entire relay lens unit 120. The relay lens unit 120 may be an erecting lens unit configured to produce an erect image from an inverted image of a distant object formed by the objective lens unit 130, so that the user can view the erect image of the distant object. The sight 100 further includes an adjusting unit (not shown) which is placed perpendicular to the first optical axis D1 and is connected to the relay lens unit 120. The user can adjust the relay lens unit 120 through the adjusting unit so that the second optical axis D2 is movable and adjustable. That is, the second optical axis D2 can be adjusted to be parallel to the first optical axis D1 or to have an included angle with the first optical axis D1. The pattern structure 1 or 1’ of the invention is formed on the first image plane P1 or the second image plane P2, namely the first light source units (not shown) and the second light source units (not shown) are placed on the first image plane P1 or the second image plane P2. The first light source units and the second light source units generate light beams, the light beams propagate toward the eyepiece lens unit 110 along the first optical axis D1, and the user can see the pattern structure 1 or 1’ through the eyepiece lens unit 110. The relay lens unit 120 may have an optical zoom feature.

The red dot sight 200 is structurally simpler than the telescopic sight 100. In the red dot sight 200, an objective lens unit 210 is included. The objective lens unit 210 has an object side surface 210a and an image side surface 210b, wherein the object side surface 210a is disposed toward the target object while the image side surface 210b is disposed toward the user. The object side surface 210a and the image side surface 210b define an optical axis D3. The objective lens unit 210 has a focus F. The pattern structure 1 or 1’ is placed at the focus F, namely the first light source unit E1 and the second light source unit E2 are placed at the focus F. The focus F is at a side of the image side surface 210b. The first light source unit E1 and the second light source unit E2 generate light beams, the light beams are reflected by the eyepiece lens unit 210 and propagate along the first optical axis D1, and the user can see the pattern structure 1 or 1’ through the eyepiece lens unit 110.

In addition to being used in a sight of a weapon, the pattern structure of the invention can be used in a telescope (not shown), wherein the relay lens unit 120 of FIG. 5 is replaced with a magnifying unit (not shown) which has zoom and magnification functions.

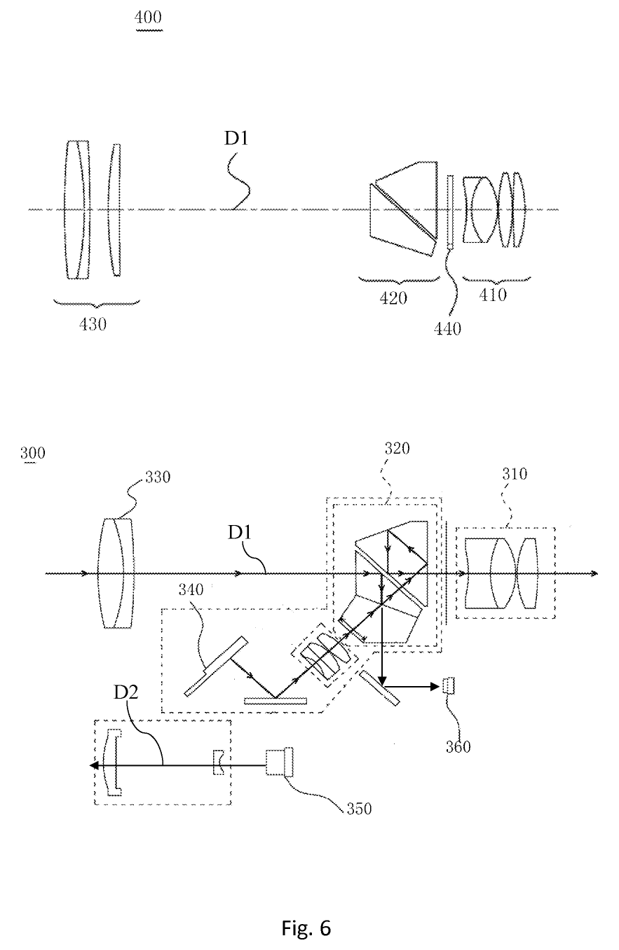

In addition to being used in a sight of a weapon, the pattern structure of the invention can be used in a range-finding device 300 (as shown in the lower part of FIG. 6). For example, the pattern structure 1, 1’ can be used for aiming at a target object (not shown) during laser ranging. The range-finding device 300 includes an eyepiece lens unit 310, a relay lens unit 320, an objective lens unit and a display unit 340, a light emitting unit 350, a light receiving unit 360, and a calculating unit (not shown). The relay lens unit 320 is disposed between the eyepiece lens unit 310 and the objective lens unit 330. The eyepiece lens unit 310 and the objective lens unit 330 jointly define the first optical axis D1. The relay lens unit 320 may be an erecting lens group for converting an inverted image of a distant object to an upright image wherein the inverted image is formed by virtue of the objective lens unit 330. The user is able to view the upright image of the distant object through the eyepiece lens unit 310. The light emitting unit 350, having a second optical axis D2, is configured to generate an emitting light beam. The first optical axis and the second optical axis are in parallel (as shown in the lower part of FIG. 6) or coincide (not shown). It is understood that the emitting light beam (the second optical axis D2) generated by the light emitting unit 350 propagates through the relay lens unit 320 to coincide with the first optical axis D1 when the light emitting unit 350 and the light receiving unit 360 are swapped in position. The emitting light beam is reflected by the target object to generate a receiving light beam. The light receiving unit 360 receives the receiving light beam, for a calculating unit to generate a distance data. The calculating unit calculates the distance of the target object based on the emission and reception of the ranging beam. For example, the distance of the target object is obtained by calculating the travel time based on the phase difference between the emission and reception of the ranging beam (the time-of-fly method, TOF method). The display unit 340 is configured to display the pattern structures 1, 1’. The display unit 340 includes the first light source unit E1 and the second light source unit E2. The display unit 340 is disposed on the first optical axis or is disposed apart from the first optical axis. When the display unit 340 is disposed apart from the first optical axis D1, the light beams generated by the first light source unit E1 and the second light source unit E2 pass through the relay lens unit 320, coincide with the first optical axis D1, and advance such that the pattern structures 1, 1’ can be viewed through the eyepiece lens unit 310. When the display unit 340 is disposed on the first optical axis D1 (see the range-finding device 400 shown in the upper part of FIG. 6), the light beams generated by the first light source unit E1 and the second light source unit E2 propagate toward the eyepiece lens unit 410 and along the first optical axis D1 such that the pattern structures 1, 1’ can be viewed through the eyepiece lens unit 410. Accordingly, the user is able to aim the pattern structures 1, 1’ (shown by the display unit 340) at the target object. Referring to the upper part of FIG. 6, the absence of a light emitting unit and the light receiving unit does not mean that they are excluded from the range-finding device 400. The upper part of FIG. 6 is provided to illustrate that the display unit 440 is disposed on the first optical axis D1 which is jointly defined by the eyepiece lens unit 410 and the objective lens unit 430, and the relay lens unit 420 is also disposed on this first optical axis D1. Therefore, other parts are omitted in the upper part of FIG. 6.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention. Further, the terms “first” and “second” described in the specification and claims are only used to distinguish between different elements, embodiments or scopes, without limiting the quantity of the elements with an upper limit or a lower limit.

What is claimed is:

1. A pattern structure, comprising:
a first pattern formed by arrangement of at least one first light source unit and corresponded to a first geometric shape;
a second pattern formed by arrangement of at least one second light source unit and corresponded to a second geometric shape;
wherein the first pattern comprises a first color and an outer edge;
wherein the second pattern comprises a first end, a second end disposed opposite to the first end, and an inner edge connecting the first end and the second end;
wherein the inner edge of the second pattern is placed corresponding to the outer edge of the first pattern;
wherein the outer edge of the first pattern and the inner edge of the second pattern have a first characteristic interval therebetween;
wherein the first end and the second end have a second characteristic interval therebetween;
wherein both the first characteristic interval and the second characteristic interval are outside the first pattern and the second pattern;
wherein both the first characteristic interval and the second characteristic interval are outside the first light source unit and the second light source unit;
wherein the first light source unit and the second light source unit individually comprises a first electrode layer, a first reflector layer, an active layer, a second reflector layer, a light-emitting side, and a second electrode layer arranged in order;
wherein the pattern structure satisfies a first group of conditions or a second group of conditions;
wherein the first group of conditions comprises L2/L1≧3 or L1≦19.95µm, where L1 is the first characteristic interval and L2 is the second characteristic interval;
wherein the second group of conditions comprises L1≦19.95µm, L2≦19.95µm, or 0.95≦L2/L1≦1.05, where L1 is the first characteristic interval and L2 is the second characteristic interval.

2. The pattern structure as claimed in claim 1, wherein the first light source unit and the second light source are resonant cavity light emitting diodes.

3. The pattern structure as claimed in claim 1, wherein:
the pattern structure is configured to operate in a first aiming mode or in a second aiming mode;
the first pattern is illuminated in the first aiming mode;
both the first pattern and the second pattern are illuminated in the second aiming mode;
a prime geometric shape is a set;
both the first geometric shape and the second geometric shape are subsets of the prime geometric shape, or alternatively, the first geometric shape is a part of the prime geometric shape and the second geometric shape is also a part of the prime geometric shape.

4. The pattern structure as claimed in claim 1, wherein when the first group of conditions is satisfied, the pattern structure is configured as follows:
the prime geometric shape is a triangle with a first dimension;
the first geometric shape is a third circle with a fourth diameter;
a third geometric shape is a fourth circle with a third diameter;
centers of the third circle and the fourth circle are placed at a vertex of the triangle;
a prime geometric shape is a set;
the second geometric shape is a difference set of the prime geometric shape and the third geometric shape;
the first geometric shape is a subset of the third geometric shape.

5. The pattern structure as claimed in claim 1, wherein:
the second pattern further comprises a second color;
the first color of the first pattern and the second color of the second pattern are identical or different;
the first characteristic interval between the outer edge of the first pattern and the inner edge of the second pattern is uniform.

6. The pattern structure as claimed in claim 1, wherein when the second group of conditions is satisfied, the pattern structure is configured as follows:
a prime geometric shape is a set;
both the first geometric shape and the second geometric shape are subsets of the prime geometric shape, or alternatively, the first geometric shape is a part of the prime geometric shape and the second geometric shape is also a part of the prime geometric shape.

7. The pattern structure as claimed in claim 1, wherein when the second group of conditions is satisfied, the pattern structure satisfies one or any combination of the following conditions:
2.85≦d3/d2≦3.5;
1.9≦d6/d2≦2.1;
8.55≦A2/A1≦12;
1.98≦A1/A3≦6;
2.85≦A3/A2≦4.6;
18.05µm≦L1≦19.95µm; and
18.05µm≦L2≦19.95µm,
where d2 is the second diameter, d3 is the third diameter, d6 is the sixth diameter, A1 is the area of first pattern, A2 is the area of second pattern, A3 is the area of the first characteristic interval, L1 is the first characteristic interval and L2 is the second characteristic interval.

8. A sight comprising:
an objective lens unit comprising an object side surface and an image side surface;
the pattern structure as claimed in claim 1;
wherein the object side surface and the image side surface define a first optical axis;
wherein the first light source unit and the second light source unit are placed at a side of the image side surface;
wherein the first light source unit and the second light source unit are configured to generate light beams, and the light beams are reflected by the objective lens unit and propagate along the first optical axis to be viewed.

9. A sight comprising:
an eyepiece lens unit;
a relay lens unit comprising a second image plane and defining a second optical axis;
an objective lens unit comprising a first image plane;
the pattern structure as claimed in claim 1;
wherein the objective lens unit and the eyepiece lens unit are configured to form a first optical axis;
wherein the relay lens unit is disposed between the objective lens unit and the eyepiece lens unit;
wherein the second optical axis is movable and adjustable to be parallel to the first optical axis;
wherein the first light source unit and the second light source unit are placed on the first image plane, or the first light source unit and the second light source unit are placed on the second image plane;
wherein the first light source unit and the second light source unit are configured to generate light beams, and the light beams propagate along the first optical axis and toward the eyepiece lens unit such that the pattern structure can be viewed through the eyepiece lens unit.

10. A range-finding device comprising:
an eyepiece lens unit;
an objective lens unit wherein the objective lens unit and the eyepiece lens unit are configured to form a first optical axis;
a light emitting unit which is configured to generate an emitting light beam and configured to form a second optical axis, wherein the emitting light beam is reflected by a target object to form a receiving light beam, and the first optical axis and the second optical axis are in parallel or coincide;
a calculating unit;
a light receiving unit configured for receiving the receiving light beam, for the calculating unit to generate a distance data;
a relay lens unit;
the pattern structure as claimed in claim 1;
wherein the first light source unit and the second light source unit are disposed on the first optical axis, or alternatively, the first light source unit and the second light source unit are disposed apart from the first optical axis;
wherein when the first light source unit and the second light source unit are disposed on the first optical axis, the first light source unit and the second light source unit generate light beams, and the light beams propagate along the first optical axis and toward the eyepiece lens unit such that the pattern structure can be viewed through the eyepiece lens unit;
wherein when the first light source unit and the second light source unit are disposed apart from the first optical axis, the first light source unit and the second light source unit generate light beams and the light beams pass through the relay lens, coincide with the first optical axis, and advance such that the pattern structure can be viewed through the eyepiece lens unit.

11. A pattern structure, comprising:
a first pattern formed by arrangement of at least one first light source unit and corresponded to a first geometric shape;
a second pattern formed by arrangement of at least one second light source unit and corresponded to a second geometric shape;
wherein the first pattern comprises a first color and an outer edge;
wherein the second pattern comprises a first end, a second end disposed opposite to the first end, and an inner edge connecting the first end and the second end;
wherein the inner edge of the second pattern is placed corresponding to the outer edge of the first pattern;
wherein the outer edge of the first pattern and the inner edge of the second pattern have a first characteristic interval therebetween that is uniform;
wherein the first end and the second end have a second characteristic interval therebetween;
wherein a prime geometric shape is a set;
wherein both the first geometric shape and the second geometric shape are subsets of the prime geometric shape, or alternatively, the first geometric shape is a part of the prime geometric shape and the second geometric shape is also a part of the prime geometric shape;
wherein the first light source unit and the second light source unit individually comprises a first electrode layer, a first reflector layer, an active layer, a second reflector layer, a light-emitting side, and a second electrode layer arranged in order;
wherein the prime geometric shape is a first circle with a first diameter;
wherein the first geometric shape is a second circle with a second diameter;
wherein the second geometric shape is an annular sector with a third diameter;
wherein the inner edge of the second pattern defines a sixth diameter;
wherein the first diameter is greater than the second diameter and is equal to the third diameter;
wherein the sixth diameter is greater than the second diameter and is less than the first diameter;
wherein centers of the first circle, the second circle and the annular sector coincide;
wherein the first characteristic interval and the second characteristic interval are equal, or the first characteristic interval and the second characteristic interval are not equal;
wherein the first geometric shape and the second geometric shape satisfy one or any combination of the following conditions:
2.85≦d3/d2≦3.5;
1.9≦d6/d2≦2.1;
8.55≦A2/A1≦12;
1.98≦A1/A3≦6;
2.85≦A3/A2≦4.6;
18.05µm≦L1≦19.95µm;
18.05µm≦L2≦19.95µm,
where d2 is the second diameter, d3 is the third diameter, d6 is the sixth diameter, A1 is the area of first pattern, A2 is the area of second pattern, A3 is the area of the first characteristic interval, L1 is the first characteristic interval and L2 is the second characteristic interval.

12. The pattern structure as claimed in claim 11, wherein the first light source unit and the second light source are resonant cavity light emitting diodes.

13. The pattern structure as claimed in claim 11, wherein:
the pattern structure is configured to operate in a first aiming mode or in a second aiming mode;
the first pattern is illuminated in the first aiming mode;
both the first pattern and the second pattern are illuminated in the second aiming mode.

14. The pattern structure as claimed in claim 11, wherein:
the second pattern further comprises a second color;
the first color of the first pattern and the second color of the second pattern are identical or different;
the first characteristic interval between the outer edge of the first pattern and the inner edge of the second pattern is uniform.

15. The pattern structure as claimed in claim 11, wherein:
both the first characteristic interval and the second characteristic interval are outside the first pattern and the second pattern;
both the first characteristic interval and the second characteristic interval are outside the first light source unit and the second light source unit.

16. A range-finding device comprising:
an eyepiece lens unit;
an objective lens unit wherein the objective lens unit and the eyepiece lens unit are configured to form a first optical axis;
a light emitting unit which is configured to generate an emitting light beam and configured to form a second optical axis, wherein the emitting light beam is reflected by a target object to form a receiving light beam, and the first optical axis and the second optical axis are in parallel or coincide;
a calculating unit;
a light receiving unit configured for receiving the receiving light beam, for the calculating unit to generate a distance data;
a relay lens unit;
the pattern structure as claimed in claim 11;
wherein the first light source unit and the second light source unit are disposed on the first optical axis, or alternatively, the first light source unit and the second light source unit are disposed apart from the first optical axis;
wherein when the first light source unit and the second light source unit are disposed on the first optical axis, the first light source unit and the second light source unit generate light beams, and the light beams propagate along the first optical axis and toward the eyepiece lens unit such that the pattern structure can be viewed through the eyepiece lens unit;
wherein when the first light source unit and the second light source unit are disposed apart from the first optical axis, the first light source unit and the second light source unit generate light beams and the light beams pass through the relay lens, coincide with the first optical axis, and advance such that the pattern structure can be viewed through the eyepiece lens unit.

17. A sight comprising:
an objective lens unit comprising an object side surface and an image side surface;
the pattern structure as claimed in claim 11;
wherein the object side surface and the image side surface define a first optical axis;
wherein the first light source unit and the second light source unit are placed at a side of the image side surface;
wherein the first light source unit and the second light source unit are configured to generate light beams, and the light beams are reflected by the objective lens unit and propagate along the first optical axis to be viewed.

18. A sight comprising:
an eyepiece lens unit;
a relay lens unit comprising a second image plane and defining a second optical axis;
an objective lens unit comprising a first image plane;
the pattern structure as claimed in claim 11;
wherein the objective lens unit and the eyepiece lens unit are configured to form a first optical axis;
wherein the relay lens unit is disposed between the objective lens unit and the eyepiece lens unit;
wherein the second optical axis is movable and adjustable to be parallel to the first optical axis;
wherein the first light source unit and the second light source unit are placed on the first image plane, or the first light source unit and the second light source unit are placed on the second image plane;
wherein the first light source unit and the second light source unit are configured to generate light beams, and the light beams propagate along the first optical axis and toward the eyepiece lens unit such that the pattern structure can be viewed through the eyepiece lens unit.

19. A telescope comprising:
an eyepiece lens unit;
a magnifying unit comprising a second image plane and defining a second optical axis;
an objective lens unit comprising a first image plane;
the pattern structure as claimed in claim 11;
wherein the objective lens unit and the eyepiece lens unit are configured to form a first optical axis;
wherein the magnifying unit is disposed between the objective lens unit and the eyepiece lens unit;
wherein the second optical axis is movable and adjustable to be parallel to the first optical axis;
wherein the first light source unit and the second light source unit are placed on the first image plane, or the first light source unit and the second light source unit are placed on the second image plane;
wherein the first light source unit and the second light source unit are configured to generate light beams, and the light beams propagate along the first optical axis and toward the eyepiece lens unit such that the pattern structure can be viewed through the eyepiece lens unit.
